(19) United States
(12) Patent Application Publication
(10) Pub. No.: US 2010/0026408 A1
(43) Pub. Date: Feb. 4, 2010

(54) SIGNAL TRANSFER FOR ULTRA-HIGH CAPACITY CIRCUITS

(76) Inventor: Jeng-Jye Shau, Palo Alto, CA (US)

Correspondence Address: JENG-JYE SHAU, 991 AMARILLO AVE., PALO ALTO, CA, 94303, US

(21) Appl. No.: 12/183,062

(22) Filed: Jul. 30, 2008

(51) Int. Cl. H01P 5/00

(52) U.S. Cl. 333/1

(57) ABSTRACT

The present invention provides high performance, low power signal transfer methods for linking large numbers of integrated chips into ultra-high capacity circuits; Example application of the present invention including ultra-high capacity memory systems, and router systems.

### BACKGROUND OF THE INVENTION

The present invention relates to signal transfer methods and structures for ultra-high capacity circuits, and more particularly to signal transfer methods and structures used to combine large number of integrated circuit (IC) chips into ultra-high capacity circuits.

In recent years, the explosive growth of internet applications has generated needs for ultra-high capacity systems. Current memory storage systems require storage capacity measured in 10¹⁵ bytes. Search engines require lookup tables with billions of indexes. Communication systems need to support thousands of ports. Existing ultra-high capacity systems are complex, expensive, power hungry, and occupy large physical spaces. For example, existing data centers have electrical power bills measured in billions of dollars. Search engines, routers, database management systems, supercomputing systems, and other systems continue to require more and more capacity, whether that capacity is measured in memory, computing speed, storage space, power consumed, or other factors. This trend shows no sign of stopping, or even slowing. It is therefore highly desirable to develop efficient methods to support ultra-high capacity systems.

One method to simplify ultra-high capacity systems is to develop high performance signal transfer methods and structures that are able to link large numbers of integrated circuit (IC) chips together at low power and small volume. The present invention is designed to provide signal transfer networks that can link hundreds, thousands, millions or more IC chips into ultra-high capacity circuits.

Prior art signal transfer methods are first discussed to facilitate an understanding of the present invention. The most common prior art method to transfer signals between multiple IC chips is to use buses. FIG. 1(a) is a symbolic diagram illustrating one example of prior art bus structures. In this example, 8 chips (C₁-C₈) share the same bus (101). If one chip wants to transfer signals to other chips, that chip needs to declare ownership of the bus, then drive the desired signals to the bus (101) so that the input circuits in other chips can receive the signals. To avoid two chips driving different signals on the same line at the same time, the data rate of a bus is limited to the data rate of a single chip. Another performance limitation of the bus structure comes from loading. The loading on a bus increases with the number of chips sharing the bus; increasing the number of chips connected to a bus causes longer delay and higher power consumption. It is therefore not practical to use bus structures for large number of chips, especially for high speed systems. Prior art bus structures are therefore not useful for linking large numbers of chips.

A prior art solution for the problem is to connect chips in tree structures. FIG. 1(b) is a symbolic diagram of an example prior art tree structure. In this example, a chip (T₁) at the root level is connected to two first level chips (T₂, T₃); T₂ is connected to two second level chips (T₄, T₅); T₃ is connected to two second level chips (T₆, T₇); T₄ is connected to two third level chips (T₈, T₉); T₅ is connected to two third level chips (T₁₀, T₁₁); T₇ is connected to three third level chips (T₁₂, T₁₃, T₁₄); T₁₁ is connected to three forth level chips (T₁₅, T₁₆, T₁₇); and T₁₄ is connected to two forth level chips (T₁₈, T₁₉). If we want to transfer a signal from T₁₆ to T₄, we need to send the signal in 4 steps (T₁₆->T₁₁->T₅->T₂->T₄). If we want to transfer a signal from T₁₄ to T₄, we need to send the signal in 5 steps (T₁₄->T₇->T₃->T₁->T₂->T₄). Each signal transfer line is connected to only two chips, so that the loadings of signal lines can be much lower than for a shared bus. It is therefore possible to connect large numbers of chips using tree structures. In a tree structure, there is typically only one possible path to send data between two chips. A “traffic jam” happens if any one of the required intermediate chips is busy. In addition, the irregular tree structures are difficult to implement on printed circuit boards. Tree structures are therefore mostly used between systems rather than between chips. Due to irregular tree structures, finding the right path from one chip to the other chip requires special protocols. One method is to send signals to all chips attached to the tree, which is wasteful. The other method is to use lookup tables to find the right path. The required lookup table can be very large for a large tree. It is highly desirable to develop methods that can avoid those problems.

The author developed wafer level inter-dice signal transfer methods and structures for integrated circuits, as disclosed in U.S. Pat. No. 6,427,222 and its continue-in-part applications. Wafer level signal transfers between integrated circuit dice on the same semiconductor substrate are certainly different than board level signal transfers using electrical connections outside of integrated circuits. However, many basic concepts developed for wafer level inter-dice signal transfers in those patents are applicable to board level inter-chip signal transfers to build high performance low power high capacity circuits.

### SUMMARY OF THE INVENTION

The primary objective of this invention is, therefore, to provide signal transfer methods and structures to support ultra-high capacity circuits comprising large numbers (more than 50) of IC chips. The other objective of this invention is to reduce power consumption of ultra-high capacity circuits. Another objective of this invention is to improve the performance of ultra-high capacity circuits.

These and other objectives are achieved by arranging IC chips in chip array(s) while executing signal transfers through inter-chip signal lines.

While the novel features of the invention are set forth with particularly in the appended claims, the invention, both as to organization and content, will be better understood and appreciated, along with other objects and features thereof, from the following detailed description taken in conjunction with the drawings.

### BRIEF DESCRIPTION OF THE DRAWINGS

FIGS. 1(a, b) are symbolic diagrams of prior art bus and tree structures;

FIG. 2 is a symbolic diagram of an orthogonal IC chip array of the present invention;

FIG. 3 is a symbolic diagram of an IC chip array of the present invention that is not orthogonal;

FIGS. 4(a-d) are symbolic diagrams showing examples of signal transfers of the present invention;

FIG. 5 is a symbolic diagram of a three-dimensional chip array of the present invention;

FIGS. 6(a-e) show one example of an application of the present invention on ultra-high capacity memory systems;

FIGS. 7(a-f) show one example of an application of the present invention on communication systems; and

FIGS. 8(a-d) show one example of the design process for a circuit board of the present invention.

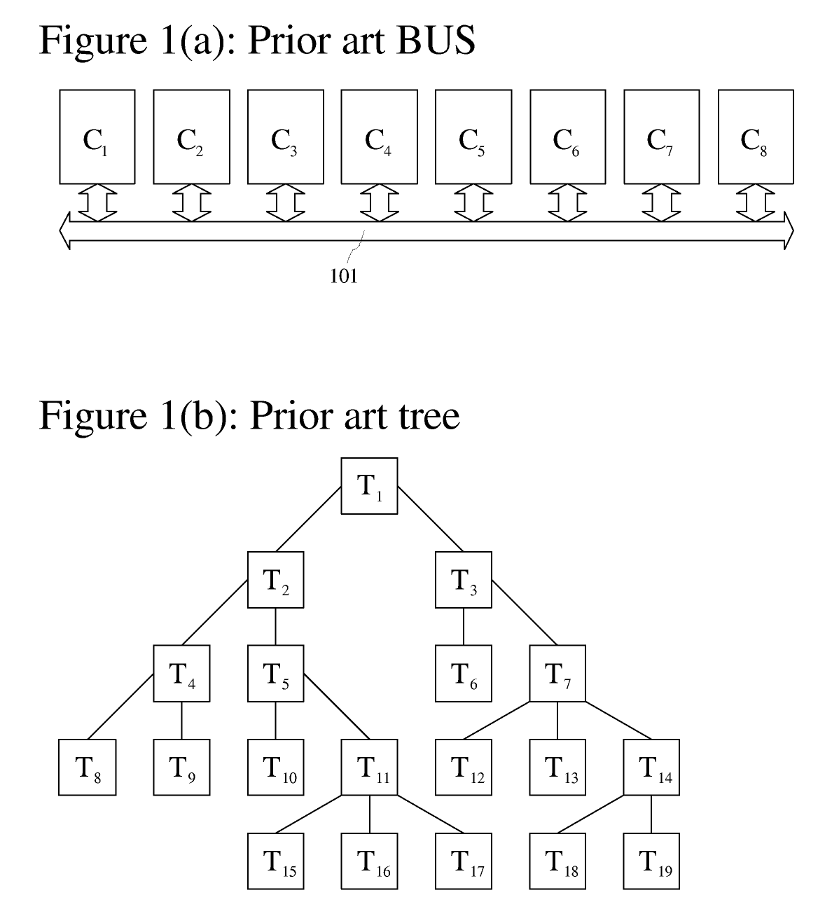

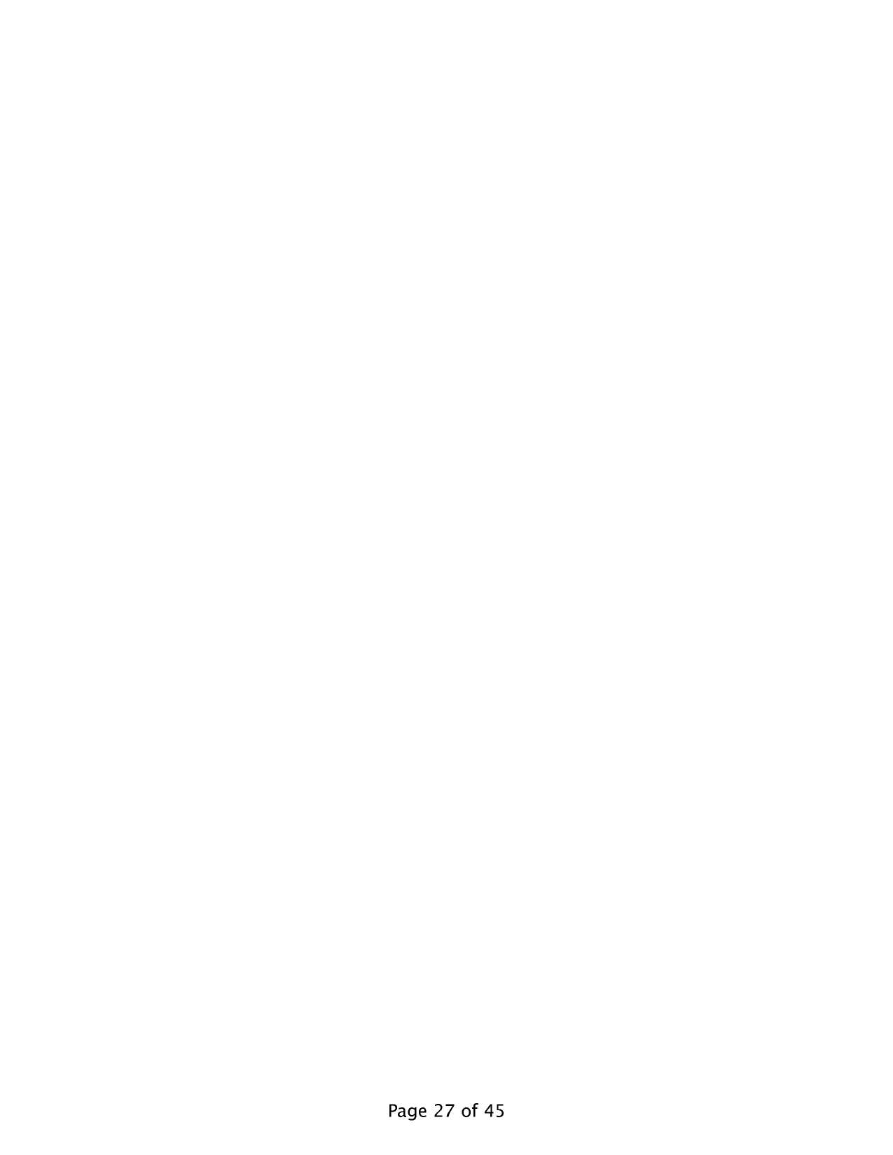

### DETAILED DESCRIPTION OF THE INVENTION

The present invention is designed to support signal transfers between many (more than 50) IC chips. For clarity, we will use simplified symbolic views with relatively small arrays in our figures. Actual implementations typically use larger arrays.

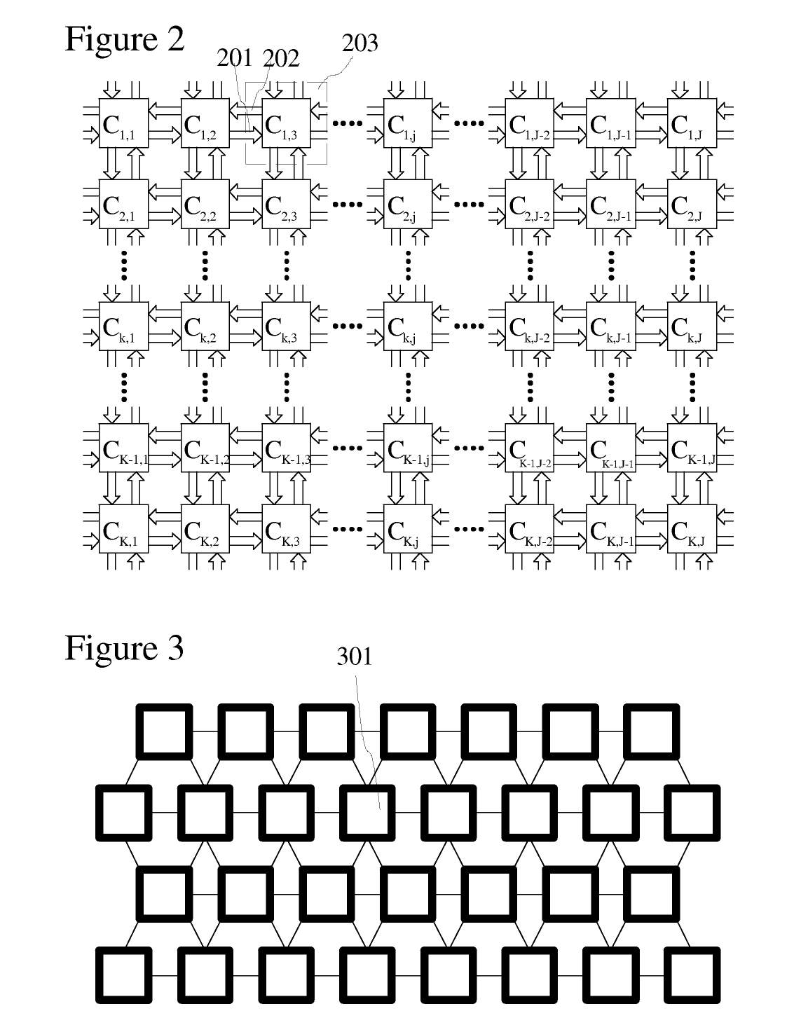

FIG. 2 is a symbolic diagram of one example IC chip array of the present invention. In this example, IC chips (C_{k,j}, where k=1−K, j=1−J) are arranged into a chip array. These chips communicate with each other through inter-chip signal lines (201, 202). This array is composed of repeating units (203) that are repeated in both horizontal and vertical directions. The chip arrays of the present invention do not need to be orthogonal. For example, FIG. 3 shows one symbolic chip array where an IC chip (301) can transfer inter-chip signals to 6 nearby IC chips.

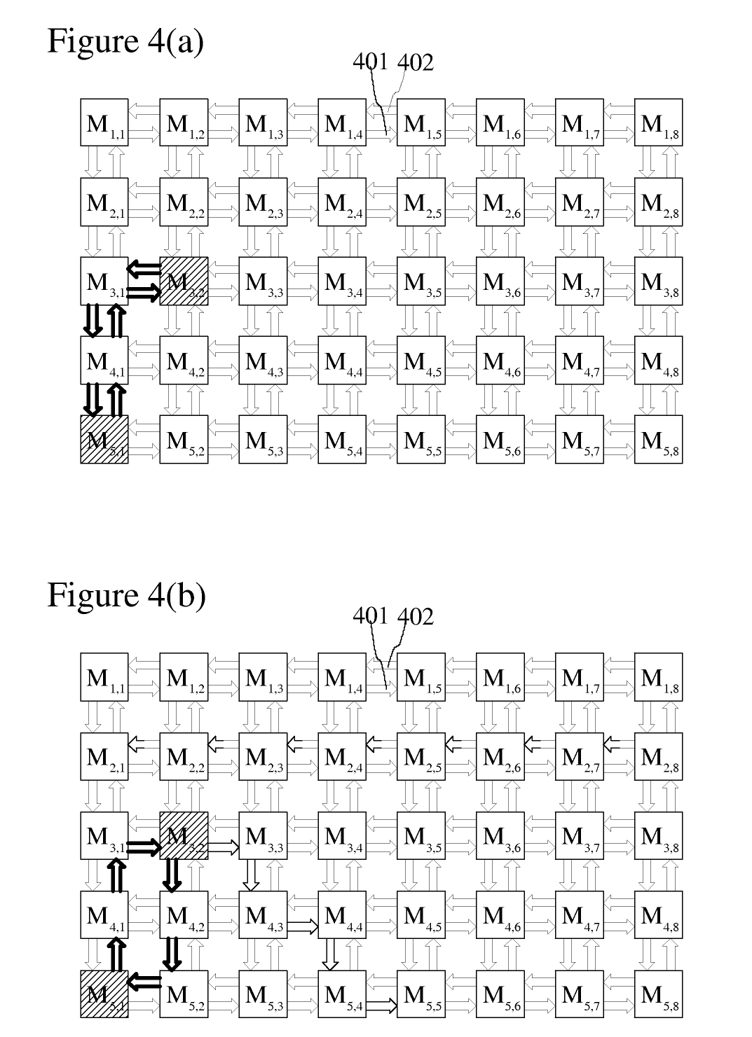

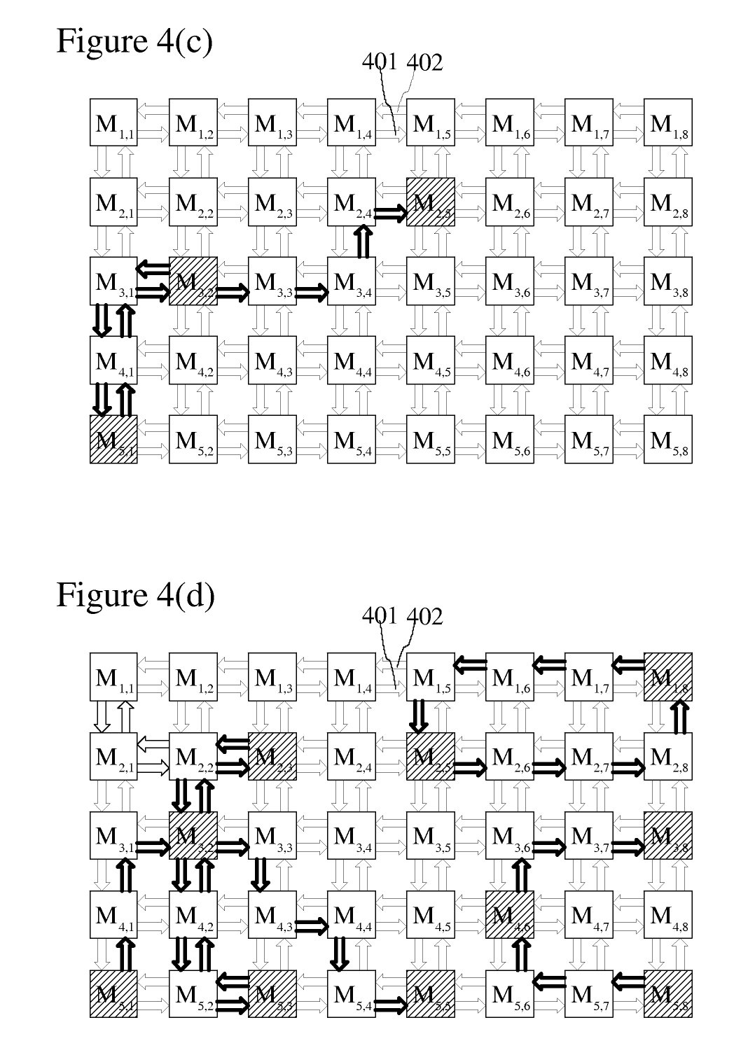

FIGS. 4(a-d) show examples of signal transfers in chip arrays. In these figures, IC chips (M_{k,j}, where k=1-5, j=1-8) are arranged in a chip array with 5 rows and 8 columns. FIG. 4(a) shows an example when a chip (M_{5,1}) transfers signals to another chip (M_{3,2}) using 3 steps of inter-chip signal transfers (M_{5,1}=>M_{4,1}=>M_{3,1}=>M_{3,2}). M_{3,2} transfers signals back to M_{5,1} using 3 steps of inter-chip signal transfers (M_{3,2}=>M_{3,1}=>M_{4,1}=>M_{5,1}). The utilized signal transfer paths are represented by bold arrows in our figures. Due to the regularity of a chip array, a row and column is sufficient to locate any specific chip. Mechanisms to locate chips in tree structures are not as simple.

In a chip array of the present invention, there are many possible paths to transfer signals between two chips. FIG. 4(b) shows an example when M_{5,1} transfers signals to M_{3,2} using the same path as that in FIG. 4(a), while M_{3,2} transfers signals back to M_{5,1} using a different path (M_{3,2}=>M_{4,2}=>M_{5,2}=>M_{5,1}). There are many other possible paths to transfer signals from M_{3,2} to M_{5,1}. Such flexibility provides options to avoid signal transfer traffic jams.

In a chip array of the present invention, one chip can have the option to execute multiple signal transfers simultaneously. FIG. 4(c) shows an example when M_{5,1} and M_{3,2} execute the same signal transfers as shown in FIG. 4(a), but M_{3,2} executes an additional signal transfer to another chip (M_{2,5}) using a 4-step path (M_{3,2}=>M_{3,3}=>M_{3,4}=>M_{2,4}=>M_{2,5}). FIG. 4(d) shows an example when multiple chips are executing multiple signal transfers simultaneously. Such flexibility allows chip arrays of the present invention to achieve extremely high signal transfer bandwidth.

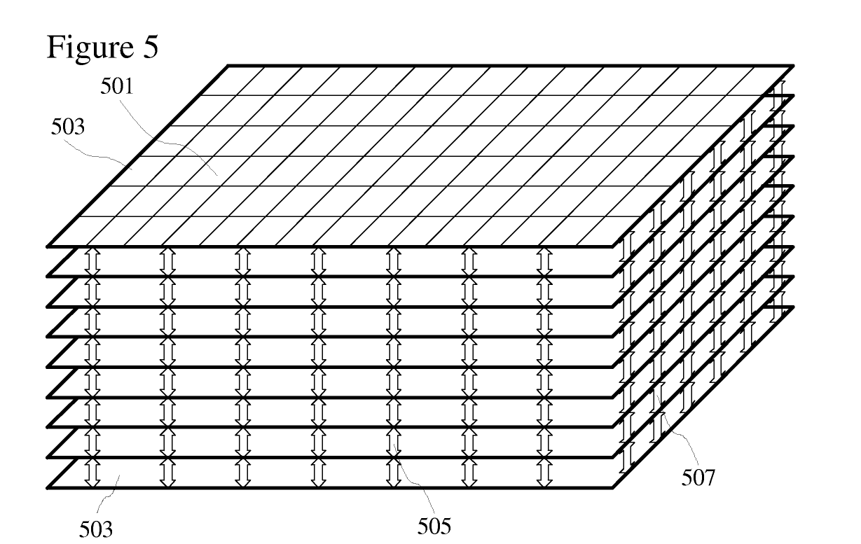

While specific embodiments of the invention have been illustrated and described herein, it is realized that other modifications and changes will occur to those skilled in the art. The scope of the present invention should not be limited by the above specific examples. FIGS. 4(a-b) showed examples of two dimensional arrays. We certainly can use different kinds of arrays such as the example shown in FIG. 3. Other types of shapes are possible as well. We also can have multi-dimensional chip arrays. FIG. 5 shows a symbolic diagram illustrating a three dimensional chip array of the present invention. The planes (503) in this example represent two dimensional arrays composed of repeating units (501). Inter-plane signal transfer paths (505, 507) provide inter-plane communication to form a three-dimensional array. There are many ways to implement such between-plane signal transfer paths. We can have such connections between every chip, between the chips only at the edges of planes, or at other selected locations.

As shown in the above examples, the IC chip array and the inter-chip signal lines of the present invention form a signal transfer network that can achieve extremely high performance. Signal transfers between neighboring chips pass through the inter-chip signal lines, while signal transfers between far away chips are achieved by a series of inter-chip signal transfers. An Inter-Chip Signal Line (ICSL) is connected to two and only two nearby chips in the chip array so that its loading is much lower than for prior art bus lines. It is therefore possible to achieve extremely high signal transfer rate through inter-chip signal lines. Signal transfer rates higher than 10⁹ bits per second (GBPS) are easily achievable. The present invention arranges IC chips in two dimensional or multi-dimensional arrays so that a chip can reach another chip in a small number of inter-chip signal transfer steps. The overhead in signal delay time is therefore small even for huge arrays. The signal transfer power consumption is low due to low loading and small numbers of steps. It is much easier to locate the position of a chip in an array structure than in a tree structure, so the locating logic is typically simpler than the locating logic for tree structures. A signal transfer network of the present invention is extremely flexible in selecting signal transfer paths. There are many more possible ways to execute signal transfers other than shown in the above figures. Multiple signal transfers can happen simultaneously in the network so we can achieve extremely high signal transfer bandwidth. Multiple available paths between two chips make it easier to avoid signal traffic jams in an array structure than in a tree structure. The chip array structures are very friendly for printed circuit designs. Large circuits comprising thousands or millions of IC chips can be implemented by repeating simple designs. To form three dimensional chip arrays, the inter-plane signal paths do not have to be placed at the edges of each plane as illustrated in FIG. 5; the vertical paths can be placed at the center, at every chip, or at any positions. It is also possible to build multi-dimensional chip arrays. Not all the signal transfers have to be executed by inter-chip signal transfers. Inter-chip signal transfer networks can work in combination with other signal transfer methods. Besides inter-chip signal transfers, we still can use buses, scan chains, daisy chains, or tree structures to support part of the signal transfer activities, especially for low performance signals. Sometimes we can add signal transfer lines that are longer than inter-chip signal lines as bypasses for long distance signal transfers.

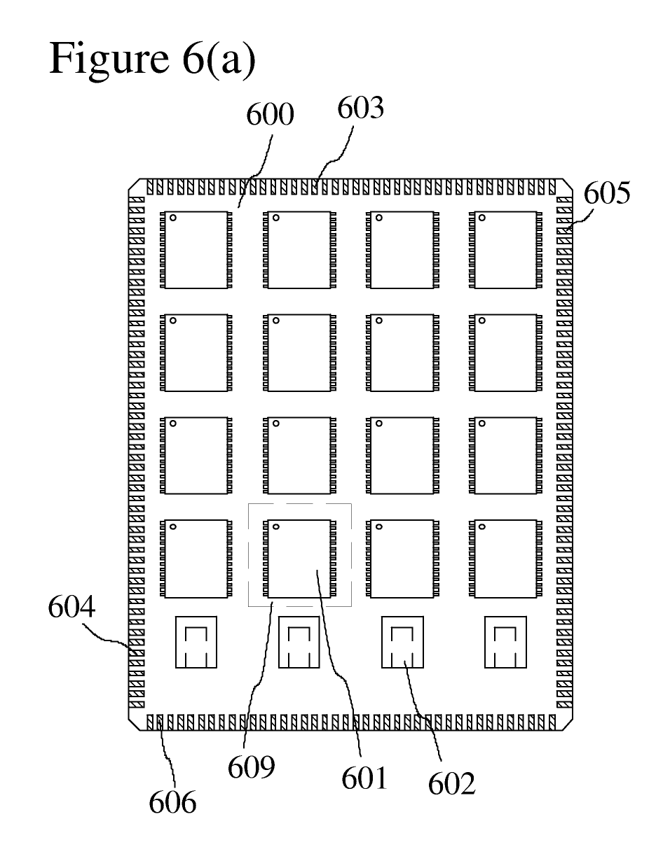

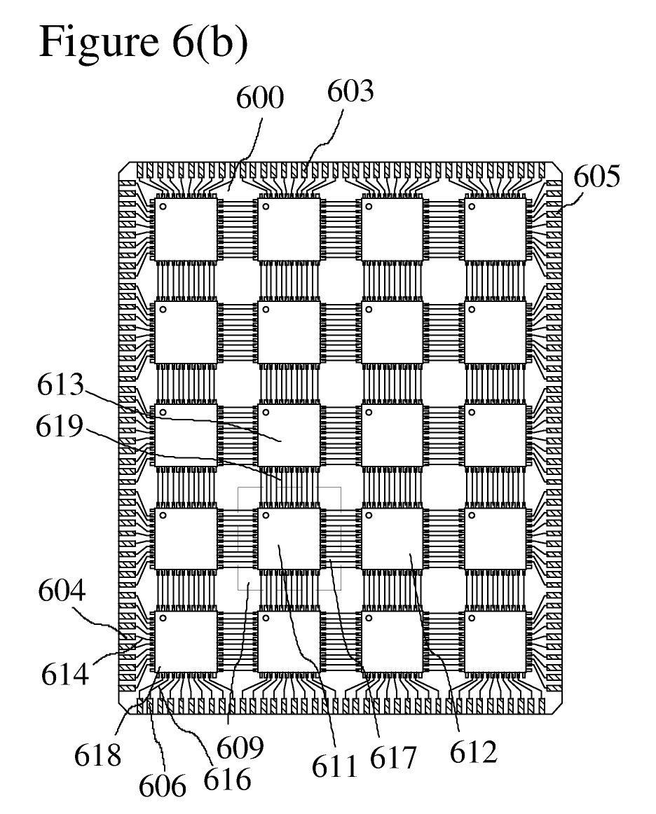

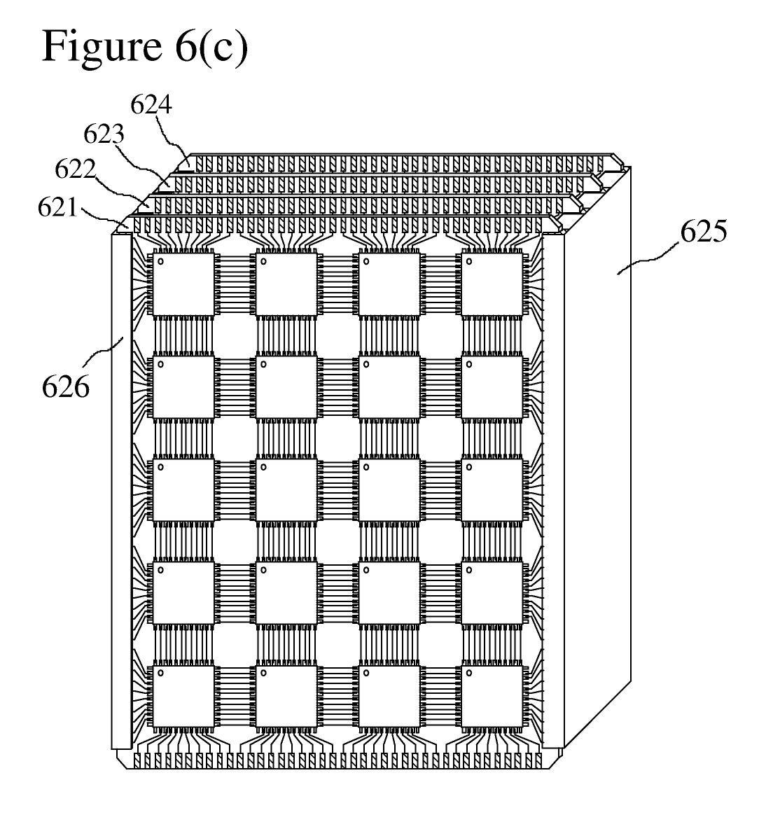

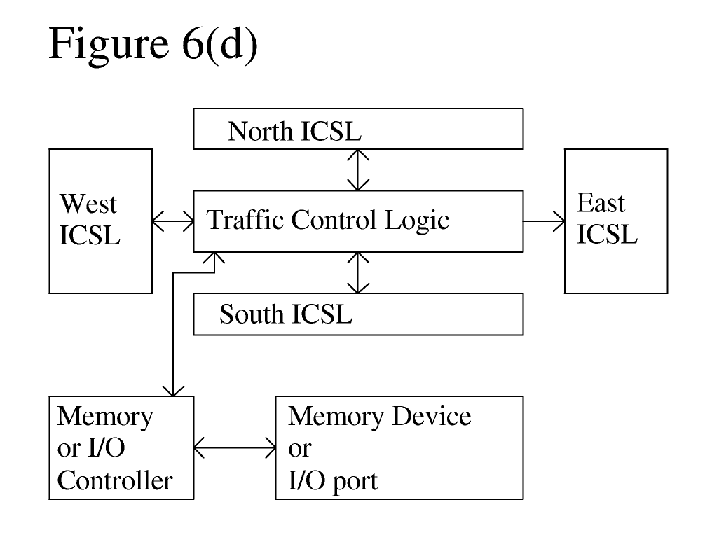

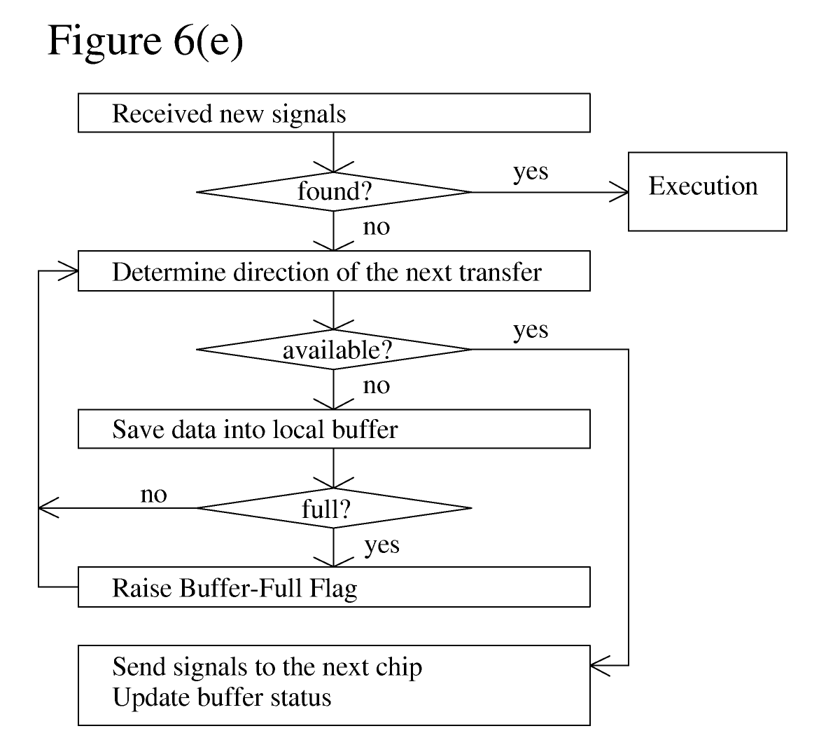

FIGS. 6(a-e) illustrate an example application of the present invention to build ultra-high capacity memory systems. FIG. 6(a) shows the top view of a circuit board (600). This circuit board is mounted with 4 rows and 4 columns of memory chips (601) and 4 interface sockets (602). For clarity, we use small numbers of chips in our examples; an actual implementation typically has more chips on a circuit board. In this example we assume the memory chips (601) are non-volatile memory chips, such as NAND FLASH, NOR FLASH, or electrically erasable programmable read only memory (EEPROM) chips. Similar designs are applicable to dynamic random access memory (DRAM) chips, static random access memory (SRAM) chips, content addressable memory (CAM) chips, other types of memory chips, or a combination of different memory chips. The interface sockets (602) are used to communicate with external systems. They can be Universal Serial Bus (USB) interfaces, Ethernet interfaces, telephone sockets, cable sockets, optical fiber interfaces, wireless interfaces, a combination of different interfaces, or any other kinds of interfaces. For expandability, the circuit board (600) has metal pins (603-606) at the 4 edges of this circuit board (600).

The chips in FIG. 6(a) are not considered a chip array of the present invention because they are not using inter-chip signal lines to transfer signals between nearby chips. In this example, the signal transfer paths for the memory chips are mounted on the other side of the circuit board. FIG. 6(b) shows the structures on the back side of the circuit board (600) in FIG. 6(a). In this example, a 5 row by 4 column IC chip array is mounted on the circuit board. Each IC chip in the chip array provides the functions of a memory controller that controls a memory chip (601) or provides the functions of an I/O controller for the interface sockets (602) at the other side of the circuit board (600). Each IC chip in FIG. 6(b) also serves the functions of Inter-Chip Signal Transfer (ICST) circuit. An ICST integrated circuit chip, by definition, is an integrated circuit chip that is capable of executing inter-chip signal transfers to three or more nearby IC chips in chip array(s). In this example, horizontal inter-chip signal lines (617) between nearby chips (611, 612) and vertical inter-chip signal lines (619) between nearby chips (611, 613) form a signal transfer network. The design of the chip array comprises multiple copies of a repeating unit (609), which is marked by dashed lines in FIG. 6(b). The repeating unit is repeated along both horizontal and vertical directions. In this example, each ICST chip in the chip array is capable of selectively transferring signals to 4 nearby chips. Signal transfers between far away chips are achieved by a series of inter-chip signal transfers using methods similar to those illustrated in FIGS. 4(a-d). When a chip (618) is at the edge of the circuit board (600), the signal lines (616, 614) of the chip (618) are connected to the edge pins (603-606) of the circuit board (600) as shown in FIG. 6(b). Such edge pin connections allow expansion using edge sockets.

FIG. 6(c) shows one example to combine multiple circuit boards to increase capacity. In this example, 4 circuit boards (621-624) are connected together using edge sockets (625-626) to form a three-dimensional chip array system. An electrical connection used for signal transfer between two and only two nearby chips in chip array(s) is an ICSL even when a socket is needed to complete the electrical connection. Therefore, the signal transfer lines at the left and right edges of the circuit boards in FIG. 6(c) also can be ICSLs if they are connected to two and only two chips. Sometimes, bus structures or other structures are used for the edge connections; under those conditions, the combination of multiple boards form a three dimensional chip array of the present invention, but the edge connections may not be ICSLs. These connections at board edges allow efficient signal transfers between ICST chips in the three-dimensional chip array.

FIG. 6(d) is a symbolic block diagram showing the logic functions of an ICST chip in the chip array in FIG. 6(b). Each ICST chip has pins connected to ICSLs to the north, east, south, and west directions. The signal transfer activities to and from those ICSLs are controlled by traffic control logic circuits. The traffic control logic circuits also communicate with Memory or I/O controllers, which control the memory chip or I/O port shown in FIG. 6(a).

FIG. 6(e) is a flow chart illustrating the functions of the traffic control logic circuits in FIG. 6(d). When an ICST chip receives a set of new signals (from ICSLs or from internal circuits), the traffic control logic circuits will check whether the chip itself is the target chip or not. If this chip is found to be the destination, the signals are sent for executions. For example, the chip may write data into a memory chip, read data from a memory chip, or send out data through an I/O interface. If the new signals are destined for other chips, then the traffic control logic circuits need to determine which ICSL paths are available. If there are no ICSL paths available, the signals are saved in a buffer waiting to be sent out at later time; a “buffer full” flag is raised if the buffer is full. If there are available paths, the traffic control logic circuits select the most efficient path, send the signals to a nearby chip through ICSLs, and update the status of buffer.

While specific embodiments of the invention have been illustrated and described herein, it is realized that other modifications and changes will occur to those skilled in the art. The scope of the present invention should not be limited by the above specific examples. There are many ways to design the traffic control logic circuits. In FIG. 6(b), the IC chips in the chip array may appear to be the same chips, but in reality an IC chip array of the present invention can have different chips as long as the chips' inter-chip signal transfer methods are compatible. For example, in FIG. 6(b) we can use different ICST chips to support memory chips and I/O ports. Sometimes, a repeating unit in a chip array of the present invention may comprise more than one chip. Sometimes, a chip array may not be fully occupied by IC chips; the user has the option to use a partially occupied chip array to allow future expansions.

The signal transfer networks of the present invention are extremely powerful. An ICSL only connects two nearby chips so there is always low loading. Using current art integrated circuits, we can easily support a data rate higher than 10⁹ bits per second (GBPS) through one ICSL. For a realistic example, assuming a circuit board has 16 by 16 ICST chips. Each ICST chip can have 16 or more ICSLs on each side. Since all the ICST chips can operate simultaneously, the peak signal transfer bandwidth for a single board exceeds 16 trillion bits per second. In addition, we can combine many boards to form a three dimensional chip array to achieve an even higher signal transfer rate as illustrated in FIG. 6(c). The loading on ICSL is typically far less than that of prior art signal transfer lines. In addition, the number of steps required to transfer each set of signals is typically much less than for prior art systems. The power consumption for circuits of the present invention is therefore typically much lower than that of prior art circuits. Circuits of the present invention also allow simultaneous access from many external ports.

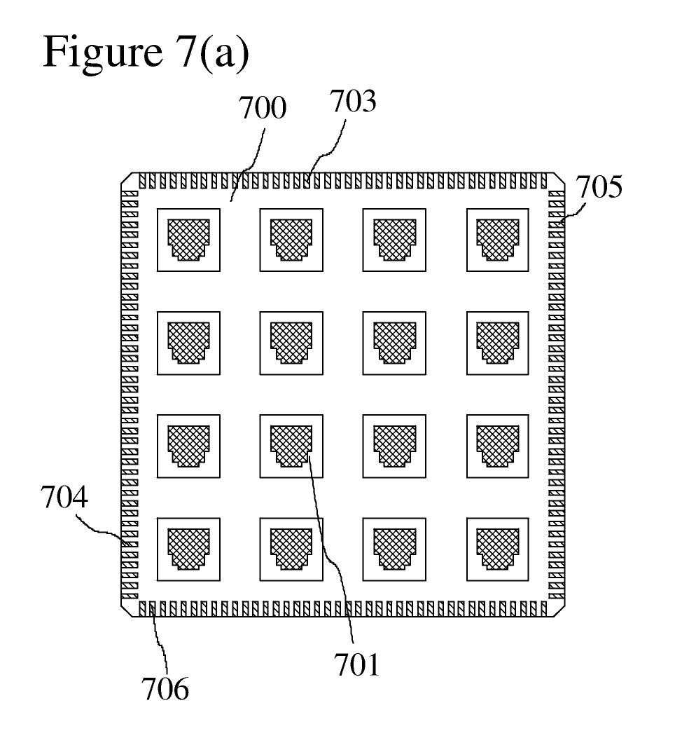

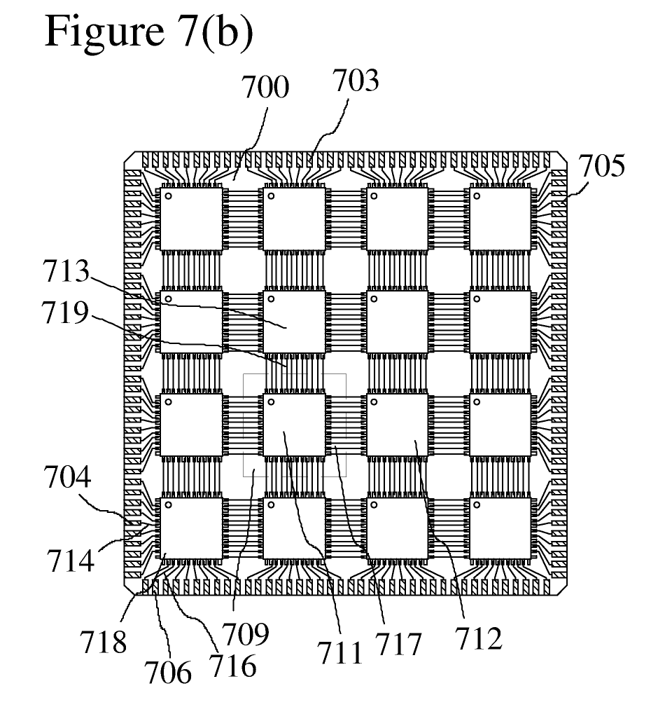

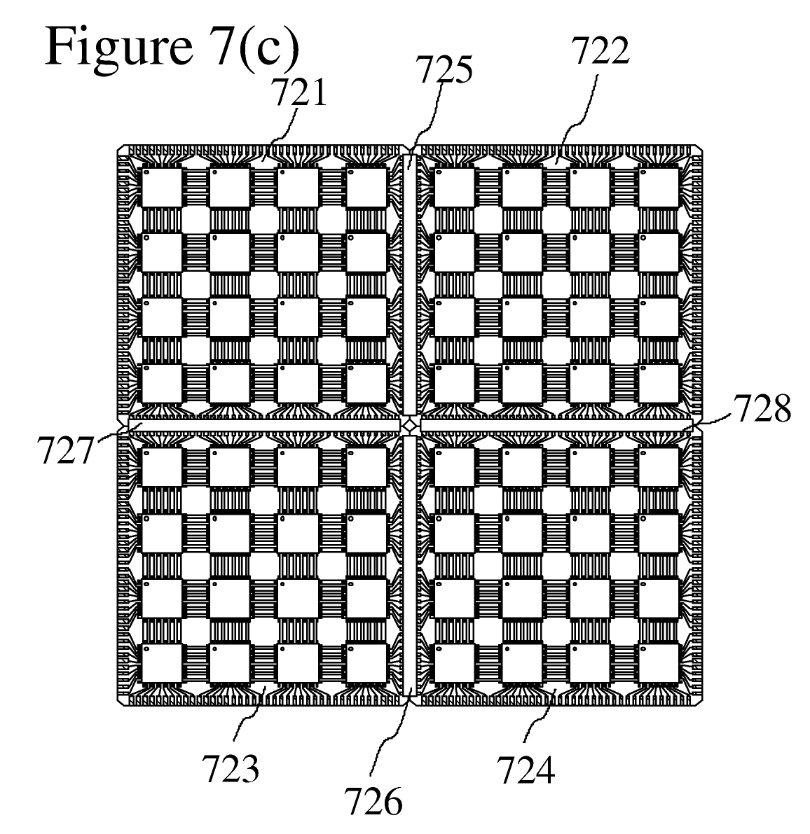

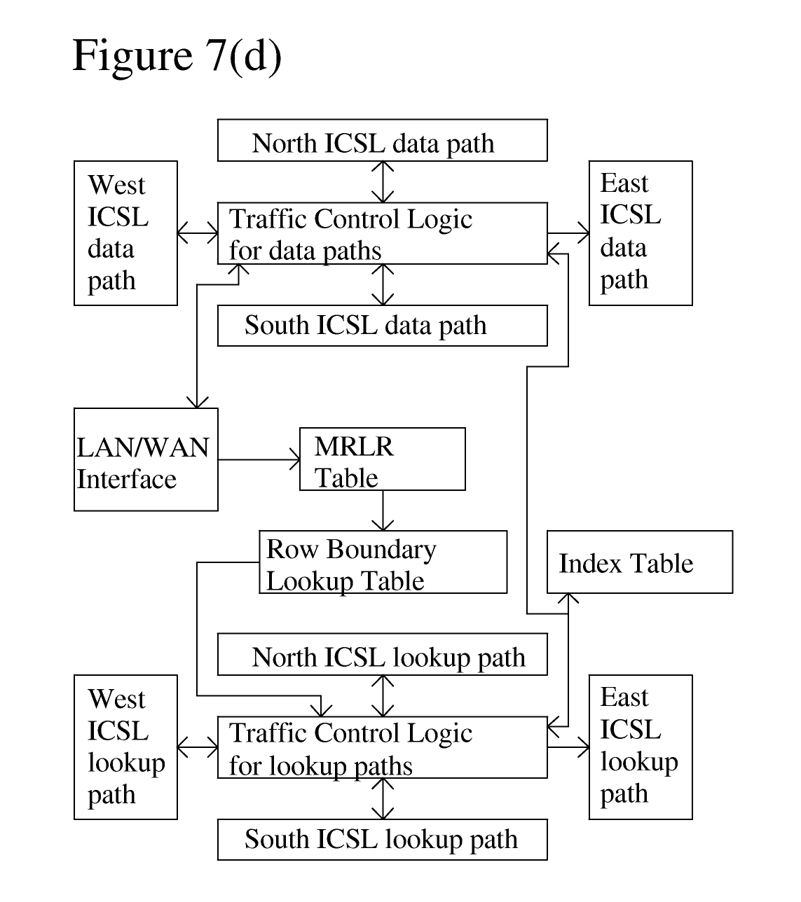

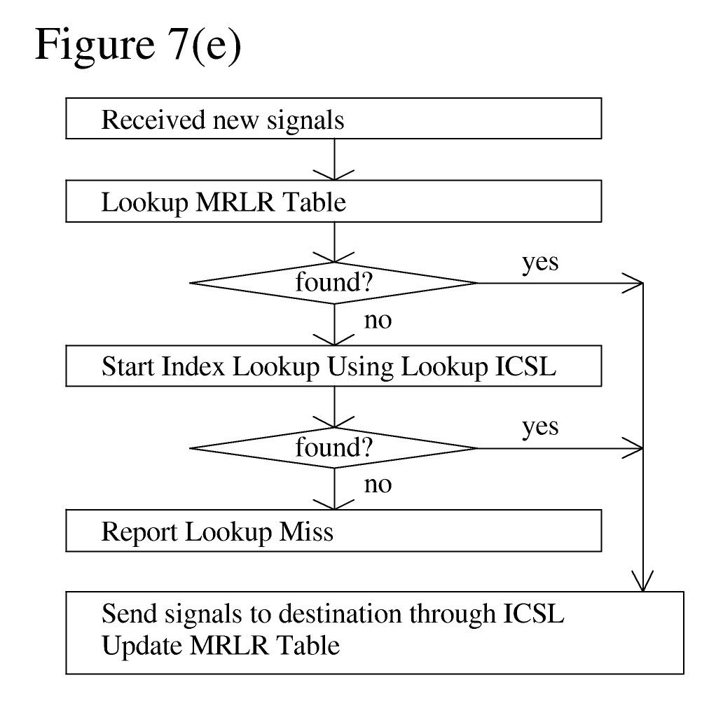

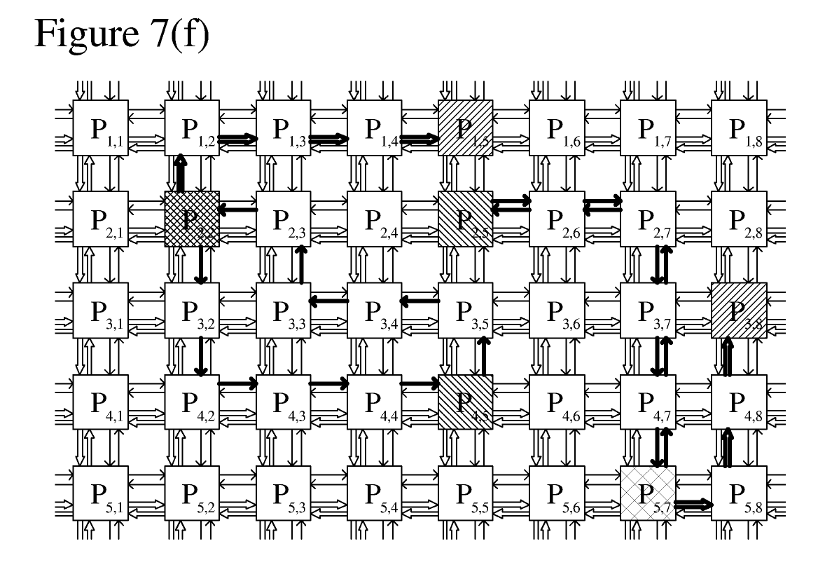

For an example memory system, we can mount 32×32 Intel SD74 64 Gbits FLASH memory chips on a circuit board in a similar design as FIG. 6(a) while using ICST chips arranged in a similar design as FIG. 6(b) to transfer control and data signals to and from those FLASH memory chips. We can expand the capacity using the expansion methods shown in FIG. 6(c) and/or FIG. 7(c) to combine many circuit boards into a single memory system. Assuming 128 circuit boards are linked in a memory system, the overall capacity of the system would be more than 10¹⁵ bytes, and the whole system would occupy just a few cubic feet. The delay time to access one of the memory chips in the chip array is equal to the delay time for memory operations plus the delay time for inter-chip signal transfers. Since inter-chip signal transfers are much faster than FLASH chip memory operations, the delay time for each memory access in chip array is not much longer than the delay time to access a single NAND FLASH memory chip. In addition, a chip array can allow thousands, millions, or more than millions of simultaneous memory accesses. The achievable data rate can be extremely high. The chip array also can support thousands, or more than thousands, of simultaneous users. The power consumed to access one of the memory chips in a chip array is equal to the power consumed by the memory chip for memory operations plus the power consumed by inter-chip signal transfers. Since inter-chip signal transfer can consume relatively less power than memory operations, the power consumed for each memory access in such a chip array is not much more than the power consumed to access a single NAND FLASH memory chip. Users will feel like they are using one memory chip with capacity measured in trillions of bytes, while consuming about the same power and operating at about the same speed as a single-chip circuit. Similar designs are also applicable to other types of memory chips.

While specific embodiments of the invention have been illustrated and described herein, it is realized that other modifications and changes will occur to those skilled in the art. The scope of the present invention should not be limited to the above specific examples. FIGS. 6(a-e) illustrate an example application of the present invention to build ultra-high capacity memory systems. The present invention is applicable to many other applications.

FIGS. 7(a-f) illustrate an example for application of the present invention to build high capacity routers. FIG. 7(a) shows the top view of a circuit board (700). This circuit board is mounted with 4 rows and 4 columns of interface sockets (701). They can be Universal Serial Bus (USB) interfaces, Ethernet interfaces, telephone sockets, co-axial cable connectors, optical fiber interfaces, wireless interfaces, a combination of different interfaces, or any other kind of interface. For expandability, the circuit board (700) typically has metal pins (703-706) at the 4 edges of this circuit board.

FIG. 7(b) shows the structures on the back side of the circuit board (700) in FIG. 7(a). In this example, a 4 row by 4 column ICST chip array is mounted on the circuit board. Each chip in the chip array provides the functions of an I/O interface controller to the interface socket (701) at the other side of the circuit board (700). Each IC chip in FIG. 7(b) also serves the functions of an Inter-Chip Signal Transfer (ICST) circuit. In this example, horizontal inter-chip signal lines (717) between nearby chips (711, 712) and vertical inter-chip signal lines (719) between nearby chips (711, 713) form a signal transfer network. The design of the chip array comprises multiple copies of a repeating unit (709) marked by dashed lines in FIG. 7(b). The repeating unit (709) is copied along both horizontal and vertical directions. Each ICST chip in the chip array is capable of selectively transferring signals to 4 nearby chips. Signal transfers between far away chips are achieved by a series of inter-chip signal transfers using methods similar to those illustrated in FIGS. 4(a-d). When a chip (718) is at the edge of the circuit board (700), the signal lines (716, 714) of the chip (718) are connected to the edge pins (703-706) of the circuit board (700) as shown in FIG. 7(b). The edge pins (703-706) allow connections to other boards to expand the capacity of the system.

The circuit board illustrated in FIGS. 7(a, b) also can be expanded to form a three dimensional array in ways similar to those shown in FIG. 6(c). There are many other ways to expand capacities. FIG. 7(c) shows another expansion example when 4 circuit boards (721-724) are connected together using edge sockets (725-728) to form a bigger board on the same plane. We certainly can attach more circuit boards to expand the chip array in horizontal direction or in vertical direction. The memory boards in FIGS. 6(a, b) also can be connected in this way.

FIG. 7(d) is a symbolic block diagram showing the logic functions of an ICST chip in the chip array in FIG. 7(b). This ICST chip has two sets of ICSL control circuits. The first set contains data ICSL circuits for transferring data signals. A set of traffic control logic circuits with functions similar to those described in FIG. 6(e) controls the data signals to ICSL data paths. The second set contains lookup path ICSL circuits for transferring address lookup signals. Another set of traffic control logic circuits with functions similar to those described in FIG. 6(e) controls the signals to ICSL lookup paths. This chip also has interface circuits to communicate with a Local Area Network (LAN) or a Wide Area Network (WAN) interface. This LAN/WAN interface circuit provides data to and from the data path traffic control logic circuits. The LAN/WAN interface circuit also connects to a Most Recently Lookup Result (MRLR) lookup table, a Row Boundary lookup table, and the lookup path traffic control logic circuits. Each chip also has an index table.

FIG. 7(e) is a flow chart illustrating example processes for address lookup operations. When an ICST chip receives a set of new signals from LAN/WAN interface, the address of the target destination is first sent to the MRLR lookup table. If the address is found in the MRLR table, the table will output the location of the target socket and the data will be sent to the target socket through inter-chip signal transfers. If the address is not found in MRLR lookup table, the address is sent through the ICSL lookup paths to index tables. If the address is found in one of the index tables in the chip array, the index table will output the location of the target socket and the data will be sent to the target socket through inter-chip signal transfers. If the address is not found in any one of the index tables, the chip will report a lookup miss to trigger miss handling processes.

FIG. 7(f) is a simplified symbolic diagram illustrating the lookup and data paths of the chip arrays in router systems of the present invention. A plurality of ICST chips (P_{i,j}, where i=1-5, j=1-8) with functions illustrated in FIGS. 7(d, e) are arranged in two dimensional chip arrays. In FIG. 7(f), each pair of nearby ICST chips communicates with two sets of ICSLs; ICSLs for lookup paths are symbolized by single-line arrows and ICSLs for data paths are symbolized by double-line arrows. The index tables in these chips store sorted indexes for all the ports connected to the system. For example, when chip P_{2,2} receives a new set of data from its WAN/LAN port, it sends the index to its MRLR table. If the index is not found in its MRLR table, it is sent to a Row Boundary lookup table in the chip. The Row Boundary lookup table stores the index with highest binary value among all indexes stored in the index tables of all chips in the same row of the chip array. This way we know which row of chips may have the right index table. For example, assuming the Row Boundary lookup table in P_{2,2} reports that the index is in row 4 of the chip array, P_{2,2} will send the index to row 4 through ICSL lookup path (P_{2,2}->P_{3,2}->P_{4,2}), as illustrated by bold arrows in FIG. 7(f). After the address reaches the target row, each chip will check its index table to determine the direction of the next lookup until an index lookup hit or miss is determined. In this example, the index travels through ICSL lookup path (P_{4,2}->P_{4,2}->P_{4,4}->P_{4,5}) and finds an index lookup hit in chip P_{4,5}. Then P_{4,5} sends the lookup results back to P_{2,2} through ICSL lookup path (P_{4,5}->P_{3,5}->P_{3,4}->P_{3,3}->P_{2,3}->P_{2,2}), as illustrated by bold arrows in FIG. 7(f). Assuming the lookup result shows that the destination is the LAN/WAN port connected to chip P_{1,5}, P_{2,2} sends the data to P_{1,5} through ICSL data path (P_{2,2}=>P_{1,2}=>P_{1,3}=>P_{1,4}=>P_{1,5}), as illustrated by bold arrows in FIG. 7(f); P_{1,5} will send the data out through its WAN/LAN port. The chip array can support multiple simultaneous lookup and data transfer activities.

For another example, chip P_{5,7} receives a new set of data from its WAN/LAN port, and the index is not found in its MRLR table. The Row Boundary lookup table in P_{5,7} reports that the index table is in row 2 of the chip array. P_{5,7} sends the index to row 2 through ICSL lookup path (P_{5,7}->P_{4,7}->P_{3,7}->P_{2,7}). After the index reaches row 2, each chip will check its index table to determine the direction of the next lookup until an address lookup hit or miss is determined. In this example, the address travel through ICSL lookup path (P_{2,7}->P_{2,6}->P_{2,5}) and finds an address lookup hit in chip P_{2,5}. P_{2,5} sends the lookup results back to P_{5,7} through ICSL lookup path (P_{2,5}->P_{2,6}->P_{2,7}->P_{3,7}->P_{4,7}->P_{5,7}), as illustrated by bold arrows in FIG. 7(f). Assuming the lookup result shows that the destination is the LAN/WAN port connected to chip P_{3,8}, P_{5,7} sends the data to P_{3,8} through ICSL data path (P_{5,7}=>P_{5,8}=>P_{4,8}=>P_{3,8}), as illustrated by bold arrows in FIG. 7(f).

While specific embodiments of the invention have been illustrated and described herein, it is realized that other modifications and changes will occur to those skilled in the art. The scope of the present invention should not be limited by the above specific examples. The above example uses separated inter-chip signal lines to support index lookup and data transfer separated. We certainly can use the same inter-chip signal lines to support both types of activities. The functions in FIG. (7d) can be supported by a single chip or several chips. We also can support multiple WAN/LAN channels using a single chip. There are many ways to design the table lookup mechanisms. For example, instead of using a row boundary table we can use a column boundary table. A system similar to the above example also can support the functions of internet search engines, database index lookups, or many other applications.

A router system of the present invention is very powerful. For example, we can have 32×32 LAN/WAN ports on a circuit board in a similar design as FIG. 7(a) while using ICST chips arranged in a similar design as FIG. 7(b) to transfer control and data signals to and from those chips. We can expand the capacity using the expansion methods shown in FIG. 6(c) and/or FIG. 7(c) to link many circuit boards into a single router system. Such a router system can support simultaneous operations for thousands or more LAN/WAN ports. In addition, the capacity of the index table of the system equals to the combined capacity of all the index tables of all chips in linked chip array(s). The overall capacity for the index lookup table can easily reach millions, billions, or more indexes, while all of them can be access using a few steps of inter-chip signal transfers as illustrated by the examples in FIG. 7(f). The router or index lookup systems of the present invention can easily reach unprecedented levels while the volume of the whole system can occupy just a few cubic feet.

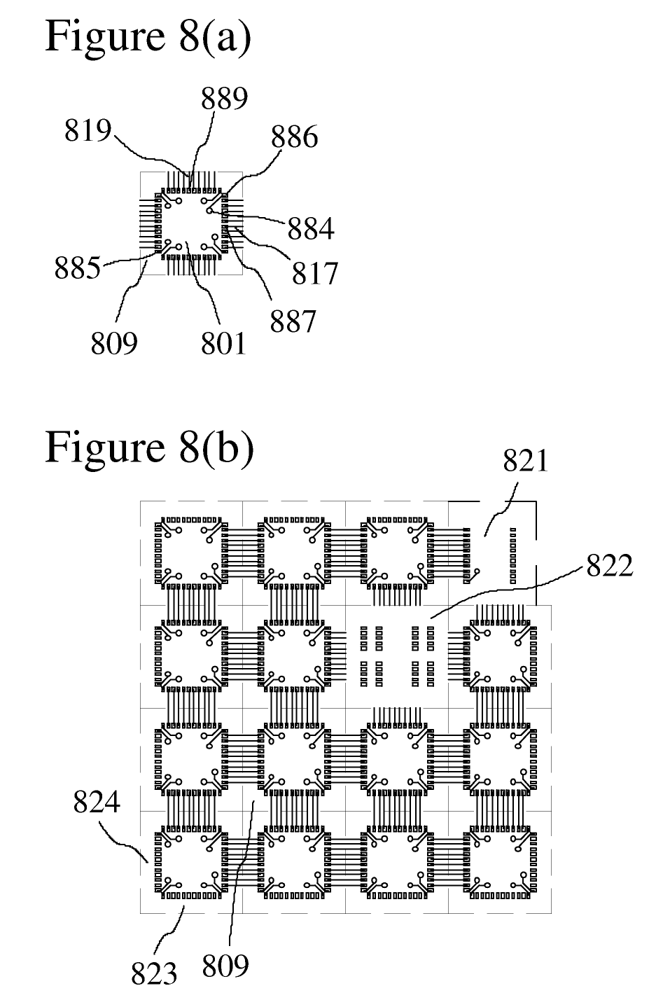

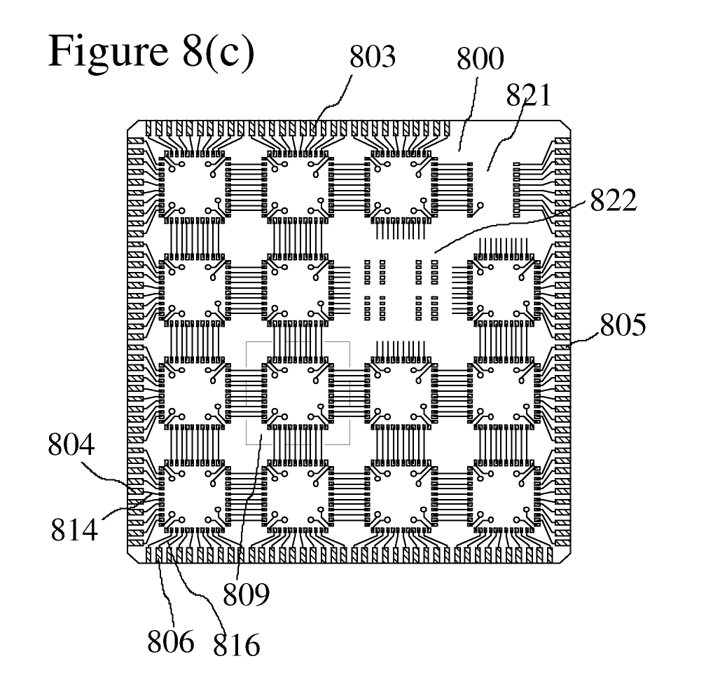

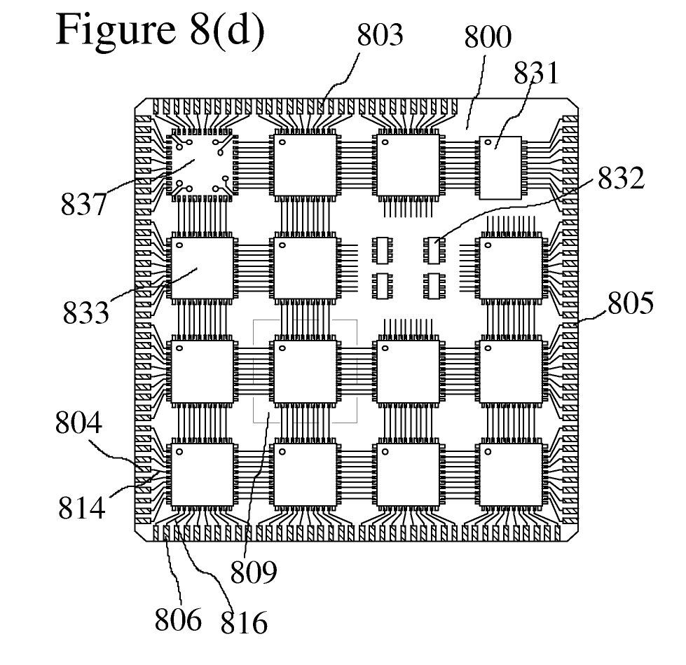

FIGS. 8(a-d) show example procedures in designing a circuit board for chip arrays of the present invention. FIG. 8(a) shows one example design of a board level repeating unit (809). In this example, the repeating pattern (809) comprises conductor pads (885-889) used to make connection with the pins of IC chips. These include conductor pads (889) that are connected to vertical conductor lines (819) for inter-chip connections, conductor pads (887) that are connected to horizontal conductor lines (817) for inter-chip connections, conductor pads (886) that are connected to via (884) for connecting to circuits on the other side of the circuit board, and power pads (885). The center space (801) of the repeating unit (809) is reserved to mount IC chips. This repeating unit (809) is typically designed using Computer Aided Design (CAD) tool on computers.

Typically, the next step is to copy the repeating unit (809) multiple times along different directions to form an array, as shown in FIG. 8(b). The repeating unit does not need to be identically copied everywhere. For example, we may use the upper right hand space (821) to mount a different IC chip. We may choose another space (822) to mount different components. At the edges (823, 824) of the array we may want to design connections different than the repeating unit (809). A chip array of the present invention comprises repeating patterns in terms of electrical connections for inter-chip signal transfers. These repeating patterns are arranged along multiple dimensions. A chip array does not have to have perfectly repeated patterns in every place. A chip array can have modifications commonly know to the art of circuit design as illustrated by the example in FIG. 8(b).

FIG. 8(c) shows a circuit board (800) design with edge pins (803-806) and edge connections (814, 816) added to the design shown in FIG. 8(b). This design is ready for manufacture by printed circuit technologies. FIG. 8(d) shows an example when ICST chips (833) arranged in chip array structures and supporting chips (831, 832) are mounted on the circuit board (800). Not all chip sites have to be occupied by chips. For example, the upper left hand site (837) in FIG. 8(d) does not have an ICST chip.

While specific embodiments of the invention have been illustrated and described herein, it is realized that other modifications and changes will occur to those skilled in the art. The scope of the present invention should not be limited by the above specific examples. There are many ways to design the repeating units for chip arrays. A chip array design certainly can comprise more than one repeating units. In our examples, IC chips are mounted on planar circuit boards. Current art circuits often mount chips on various substrates, such as flexible ribbon circuit boards. In our examples, each board comprises a chip array with multiple chips. Sometimes it is desirable to place only one IC chip on a small board, and form a chip array by linking many one-chip boards.

In our terminologies, an IC chip is a packaged integrated circuit. A bare-die IC that is mounted directly on a circuit board using chip-on-board technology or other direct mounting technologies is considered an IC chip because chip-on-board is still a form of packaging. However, an integrated circuit die on semiconductor wafer that has not been sliced is not considered an IC chip. An array, by definition, comprises repeating structures along two or more dimensions. The array defined by the present invention does not have to be a “perfect array” that has identical repeating structures everywhere. As soon as repeating structures are copied multiple times along two or more dimensions, we call it an array. An IC chip array of the present invention is a plurality of integrated circuit chips arranges in two dimensional or multiple dimensional array(s) wherein inter-chip signal lines are connected between nearby IC chips. The key point is that the inter-chip signal transfer paths must be able to transfer signals in regularly repeating patterns along multiple dimensions—forming signal transfer network(s). A scan chain or a daisy chain is not a chip array of the present invention because their chips are linked in one dimension instead of multiple dimensions. A tree structure is not a chip array because tree structures lack the regularity of chip arrays; tree structures also do not have the flexibility in selecting signal transfer paths as chip arrays. An Inter-Chip Signal Line (ICSL) of the present invention, by definition, is a short electrical connection that is used to transfer signals between and only between two nearby IC chips. An ICSL is typically a short conductor line connects one pin of an IC chip to one and only one pin of a nearby IC chip in a chip array. Sometimes an ICSL may not be a simple conductor line; it may comprise components such as current-limiting serial resistor(s), voltage limiting resistor(s) or diode(s), or a socket linking two circuit boards. A pair of matched lines sending one differential signal between two and only two nearby chips in a chip array also can be considered as ICSLs. The key requirement for ICSL is that it is connected between two and only two nearby IC chips in a chip array and the line must be short. Any electrical connections traveling more than 10 cm would not be considered an ICSL of the present invention. An ICSL also must be a board level electrical connection. Wafer level conductor lines deposited on semiconductor substrate are not inter-chip signal lines. Box level or system level connections such as telephone wires, Ethernet cables, co-axial cables, or wireless connections, are not inter-chip signal lines of the present invention. By definition, an Inter-Chip Signal Transfer (ICST) integrated circuit chip of the present invention is an IC chip that (1) can interface to inter-chip signal lines to three or more nearby IC chips in chip array(s), and (2) has the capability to transfer signals selectively to three or more nearby IC chips in chip array(s) using inter-chip signal lines. An ICST chip also can have other functions such as memory controller, networking, signal processing, and so on, but it must meet the above two requirements. In a signal transfer network the signal transfer lines are connected in net-like structure so that, for most of cases, there are multiple signal transfer paths available between two chips.

While specific embodiments of the invention have been illustrated and described herein, it is realized that other modifications and changes will occur to those skilled in the art. It is therefore to be understood that the appended claims are intended to cover all modifications and changes as fall within the true spirit and scope of the invention.

What is claimed is:

1. A method to transfer signals between more than 50 integrated circuit chips, this method comprising the steps of:
Providing a plurality of inter-chip signal lines, wherein an inter-chip signal line is (1) a short electrical connection traveling no more than 10 cm, and (2) an electrical connection supporting signal transfers between and only between two integrated circuit chips;
Providing a plurality of Inter-Chip Signal Transfer (ICST) integrated circuit chips arranged in chip array(s), wherein an ICST chip is an integrated circuit chip capable of selectively transferring signals using inter-chip signal lines to three or more nearby ICST chips in the chip array(s);
Wherein the inter-chip signal transfer lines and the inter chip signal transfer integrated circuit chips form a signal transfer network.

2. The method in claim 1 supports signal transfers to communication ports.

3. The method in claim 2 supports signal transfers to communication ports using telephone lines.

4. The method in claim 2 supports signal transfers to communication ports using Ethernet cables.

5. The method in claim 2 supports signal transfers to wireless communication ports.

6. The method in claim 1 supports signal transfers to integrated circuit memory chips.

7. The method in claim 6 supports signal transfers to non-volatile memory chips.

8. The method in claim 7 supports signal transfers to FLASH memory chips.

9. The method in claim 6 supports signal transfers to Static Random Access Memory (SRAM) chips.

10. The method in claim 6 supports signal transfers to Dynamic Random Access Memory (DRAM) chips.

11. The method in claim 6 supports signal transfers to content addressable memory (CAM) chips.

12. The method in claim 1 supports index table lookup operations.
